(19) United States
(12) Patent Application Publication
(10) Pub. No.: US 2012/0328742 A1
(43) Pub. Date: Dec. 27, 2012

(54) Decorative Toothpick Mold

(76) Inventor: Traci Jones, St. Louis, MO (US)

(21) Appl. No.: 13/490,503

(22) Filed: Jun. 7, 2012

Related U.S. Application Data
(60) Provisional application No. 61/500,891, filed on Jun. 24, 2011.

(51) Int. Cl. A47G 21/00; A23G 3/54; A23G 3/56

(52) U.S. Cl. 426/91; 294/61; 426/104

(57) ABSTRACT

An architecture is presented that provides a decorative toothpick device designed primarily for use with chocolate-covered strawberries, cupcakes, cake pops, pastries, or other food articles. The decorative toothpick device comprises a toothpick comprising a first end and a second end, and a decorative molded topper secured to the first end of the toothpick. The second end of the toothpick is then inserted into a confection. The decorative toothpick device would then act as a decorative top piece, as well as a handle with which to eat the strawberry, the cupcake, the cake pop, or the cookie, etc. The decorative toothpick device can come in a ready-to-use package, or be prepared by hand by a user. Furthermore, the decorative molded toppers can be decorated in a variety of designs and themes, depending on the occasion. For example, any kind of additional additive can be used to decorate the decorative molded toppers.

### CROSS-REFERENCE

This application claims priority from Provisional Patent Application Ser. No. 61/500,891 filed Jun. 24, 2011.

### BACKGROUND

Chocolate-covered strawberries are a popular and delicious treat that can be made as a snack or as a gift. They can be difficult to eat though, and individuals may have to hold onto the green, stem-like leaves on the top while trying to eat the strawberries. However, this portion of the strawberry can be unreliable and can easily rip off, causing the individual to drop the entire strawberry or get chocolate or other topping on their clothes. Additionally, some individuals may choose to purchase plastic toppers and place them in the top of the strawberry, but these toppers are inedible and do not blend in very well with the colorful strawberry and chocolate. Consequently, an effective solution is necessary.

There is a need for an improved topper for chocolate-covered (or any other covering/coating) strawberries or other confections that provides users with an edible handle and does not create more of a mess while eating the strawberries or other confections. The present invention discloses a decorative toothpick mold that is an edible topper for chocolate-covered strawberries or other fruits, and can also be used for caramel apples, cupcakes, cake pops and other confections and finger foods. The disclosed invention provides individuals with a small, edible handle, enabling them to eat the food article and the handle without making a mess. The decorative toothpick device can come in a variety of themes to suit different occasions, such as weddings, birthdays, graduations, and seasonal holidays. By using this invention, users can add a fun and decorative flair to an otherwise plain yet popular treat. All users will appreciate the appeal and functionality that this invention affords.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a decorative toothpick device designed primarily for use with chocolate-covered strawberries or other fruits, caramel apples, cupcakes, cake pops, or other confections or finger foods. The decorative toothpick device comprises a toothpick comprising a first end and a second end, and a decorative molded topper secured to the first end of the toothpick. The second end of the toothpick is then inserted into the confection or finger food. The decorative toothpick device would then act as a decorative top piece, as well as a handle with which to eat the strawberry (or other fruit), the cake pop, the cupcake, or other article of food. The decorative toothpick device can come in a ready-to-use package, or be prepared by hand by a user.

Furthermore in the preferred embodiment of the present invention, the decorative molded toppers can be decorated in a variety of designs and themes, depending on the occasion. For example, any kind of additional additive can be added to the decorative molded toppers, such as sprinkles, colored edible paint, frosting, candies, etc., or any other suitable additive as is known in the art can be used to decorate the decorative molded toppers.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a decorative toothpick device in accordance with the disclosed architecture.

FIG. 2 illustrates a perspective view of the decorative toothpick device inserted into chocolate-covered strawberries in accordance with the disclosed architecture.

FIG. 3 illustrates a perspective view of the decorative toothpick device inserted into chocolate-covered strawberries decorated in a wedding theme in accordance with the disclosed architecture.

FIG. 4 illustrates a perspective view of the decorative toothpick device inserted into a plurality of chocolate-covered strawberries in accordance with the disclosed architecture.

FIG. 5 illustrates a perspective view of the decorative toothpick device inserted into chocolate-covered strawberries in accordance with the disclosed architecture.

FIG. 6 illustrates a perspective view of the decorative toothpick device inserted into chocolate-covered strawberry in accordance with the disclosed architecture.

FIG. 7 illustrates a perspective view of the decorative toothpick device inserted into chocolate-covered strawberry in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a decorative toothpick device that is an edible topper for chocolate-covered strawberries or other fruit, and can also be used for caramel apples, cupcakes, cake pops, and other confections or finger food. The disclosed invention provides individuals with a small, edible handle, enabling them to eat the attached food article (e.g., a strawberry) and the handle without making a mess. The decorative toothpick device comprises a toothpick, and an edible, decorative molded topper secured to an end of the toothpick. The opposite end of the toothpick is then inserted into a chocolate-covered strawberry or other fruit, or other confection or food article. The decorative toothpick device would then act as a decorative top piece, as well as a handle with which to eat the attached food article.

The decorative toothpick device can come in a variety of themes to suit different occasions, such as weddings, birthdays, graduations, seasonal holidays, etc. Additionally, the decorative toothpick device can come in a ready-to-use package, or be prepared by hand by a user. By using this invention, users can add a fun and decorative flair to an otherwise plain yet popular treat.

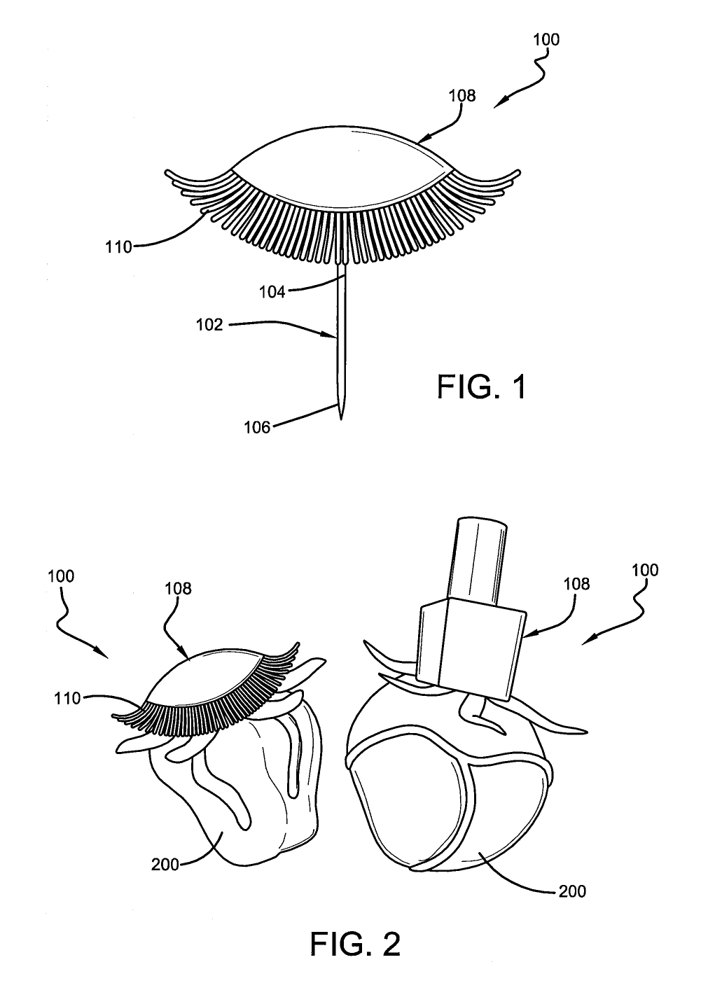

Referring initially to the drawings, FIG. 1 illustrates a decorative toothpick device 100 designed primarily for use with chocolate-covered strawberries or other fruit, caramel apples, cupcakes, cake pops, or other confections or food articles. The decorative toothpick device 100 comprises an elongated member or a toothpick 102 comprising a first end 104 and a second end 106. If a toothpick is used, the toothpick 102 would have the appearance of a typically constructed toothpick as is known in the art. Typically, the toothpick 102 is cylindrical in shape, however any other suitable shape can be used as is known in the art without affecting the overall concept of the invention. The elongated member or toothpick 102 would generally be constructed of wood or plastic, though any other suitable material may be used to manufacture the elongated member or toothpick 102 as is known in the art without affecting the overall concept of the invention. The elongated member or toothpick 102 is approximately between 1 and 4 inches in length as measured from first end 104 to second end 106, and approximately between 1/16^{th} and 3/16^{th} of an inch in diameter.

The decorative toothpick device 100 further comprises an edible, decorative molded topper 108 secured to the first end 104 of the toothpick 102. The decorative molded topper 108 can be comprised of chocolate, candy, caramel, or any other suitable, edible material that can be poured into a mold and solidified. Typically, the toothpick 102 is placed in a food-grade mold that is designed for use at elevated temperatures or with heated liquids. The mold can be any decorative mold as is known in the art, and can be designed in a variety of themes to suit different occasions and celebrations, such as weddings, birthdays, showers, holidays, graduations, etc. Then, hot chocolate, candy, or caramel, or other suitable, edible material is poured into the molds. After the chocolate, candy, caramel, or other suitable, edible material hardens, the decorative molded toppers 108 are removed from the molds. The decorative molded toppers 108 can then be further decorated depending on the occasion. For example, any kind of additional additive 110 can be added to the decorative molded toppers 108, such as luster dust, edible glitter, edible decorations, sprinkles, colored edible paint, frosting, candies, edible picture images, etc., or any other suitable additive as is known in the art can be used without affecting the overall concept of the invention. In FIG. 1, for example, the decorative molded topper 108 comprises an eyelid with additional additives 110 creating the eyelashes.

FIG. 2 illustrates the decorative toothpick device 100 inserted into chocolate-covered strawberries 200. Specifically, the second end 106 of the toothpick 102 is inserted into the top of a fruit or a confection, such as a chocolate-covered strawberry or other fruit, a caramel apple, a cupcake, a cake pop, a cookie, pastries, or any other suitable fruit, confection or food article as is known in the art without affecting the overall concept of the invention. The decorative toothpick device 100 would then act as a decorative top piece, as well as a handle with which to eat the strawberry, the caramel apple, the cake pop, the cupcake, or the cookie, the pastry, etc. The decorative toothpick device 100 can be offered in a variety of designs and themes, and can come in a ready-to-use package, or be prepared by hand by a user.

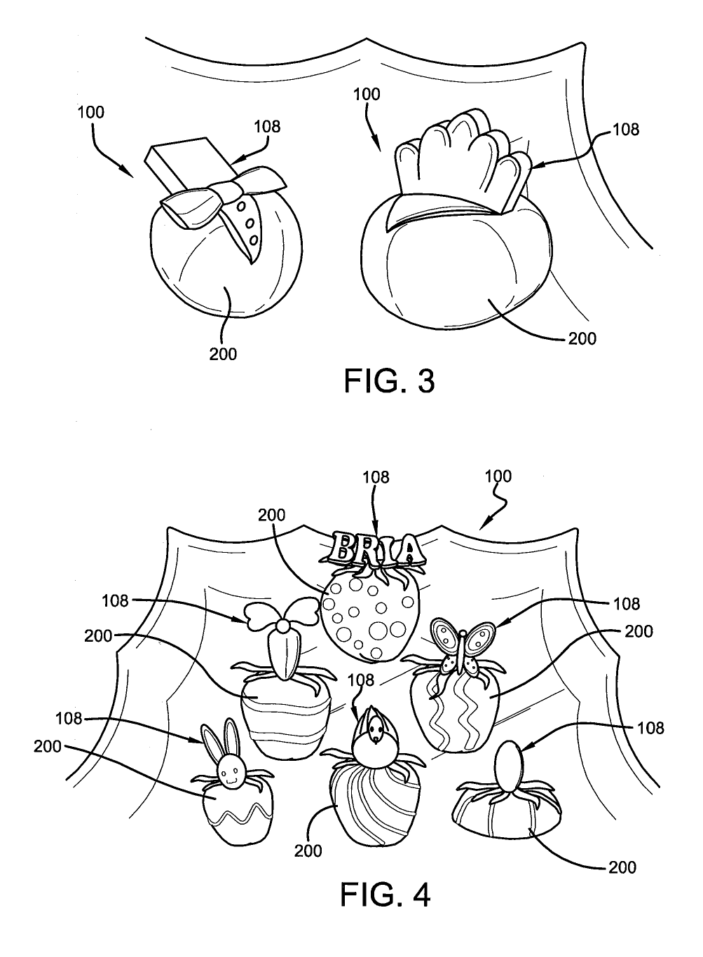

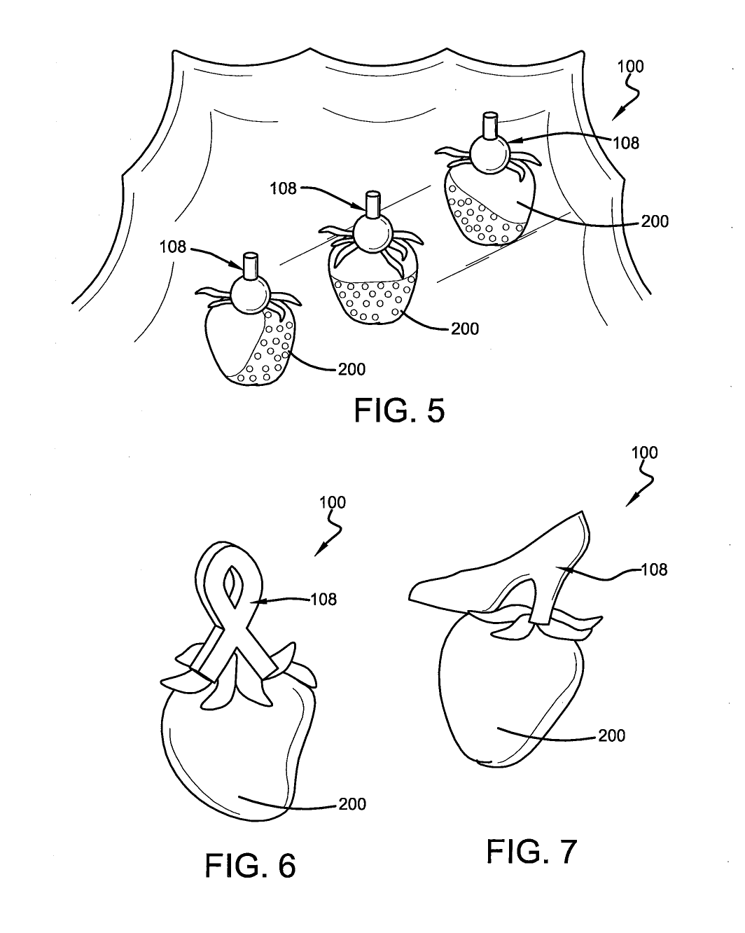

FIGS. 3-7 illustrate the decorative toothpick device inserted into chocolate-covered strawberries decorated in various designs or themes. For example, FIG. 3 discloses the decorative toothpick device 100 inserted into chocolate-covered strawberries 200 which are decorated to resemble a bride and a groom. The decorative molded topper 108 is a chocolate molded groom hat and bride's tiara and veil. FIG. 4 discloses the decorative toothpick devices 100 inserted into chocolate-covered strawberries 200 of various designs. Specifically, the decorative molded toppers 108 are chocolate molds of butterflies, vegetables, and letters spelling out names and other words. FIG. 5 discloses the decorative toothpick devices 100 inserted into chocolate-covered strawberries 200 that are decorated with colored icing or edible paint and additional additives. Specifically, the decorative molded toppers 108 are chocolate nail polish bottles decorated with colored icing or edible paint of different colors. FIG. 6 discloses the decorative toothpick device 100 inserted into a chocolate-covered strawberry 200 which is decorated to resemble a pink breast cancer ribbon. FIG. 7 discloses the decorative toothpick device 100 inserted into a chocolate-covered strawberry 200, which is decorated to resemble a high-heeled shoe.

In operation, a user would purchase a specific food-grade mold that is designed for use with heated liquids or at elevated temperatures. The mold can be any decorative mold as is known in the art, and can be designed in a variety of themes to suit different occasions and celebrations, such as weddings, birthdays, showers, holidays, graduations, etc. Then, a user would pour hot chocolate, candy, or caramel, or other suitable, edible material into the molds. After the chocolate, candy, caramel, or other suitable, edible material hardens, the user would remove the decorative molded toppers from the molds. The molds are re-useable and can be used as often as needed. A user can then decorate the decorative molded toppers with additional additives depending on the wants and needs of the user, and/or the occasion or celebration. For example, any kind of additional additive can be added to the decorative molded toppers, such as luster dust, edible glitter, edible decorations, sprinkles, colored edible paint, frosting, candies, edible picture images, etc. Or, the decorative toothpick devices can come in a ready-to-use package, in which a user can purchase the decorative toothpick devices based on a specific theme or design. The user then removes the decorative toothpick devices from the packages and inserts the toothpick end of the decorative toothpick devices into a top of a chocolate-covered strawberry or other fruit, caramel apple, cake pop, cupcake, cookie, pastry, or other confection or food article, or more than one confection or food article. The decorative toothpick device then acts as a decorative top piece, as well as a handle with which to eat the strawberry or other fruit, confection, or other food article.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A decorative toothpick device, comprising:
an elongated member comprising a first end and a second end; and
a decorative molded topper secured to the first end of the elongated member; and
wherein the second end of the elongated member is then inserted into a food article.

2. The decorative toothpick device of claim 1, wherein the decorative molded topper comprises chocolate.

3. The decorative toothpick device of claim 1, wherein the decorative molded topper comprises candy.

4. The decorative toothpick device of claim 1, wherein the decorative molded topper comprises an edible additive.

5. The decorative toothpick device of claim 4, wherein the edible additive comprises at least one of luster dust, edible glitter, edible decorations, sprinkles, edible paint, frosting, edible picture image, or fondant.

6. The decorative toothpick device of claim 1, wherein the food article comprises at least one of a chocolate-covered strawberry, a caramel apple, a cupcake, a cookie, a cake pop, or a pastry.

7. The decorative toothpick device of claim 1, wherein the elongated member is approximately between 1 and 4 inches in length.

8. The decorative toothpick device of claim 1, wherein the decorative molded topper is shaped as an eyelash.

9. The decorative toothpick device of claim 1, wherein the decorative molded topper is shaped as a butterfly.

10. The decorative toothpick device of claim 1, wherein the decorative molded topper is shaped as a nail polish bottle.

11. A decorative handle device for a food article, comprising:
an elongated member comprising a first end and a second end; and
a chocolate molded topper secured to the first end of the elongated member; and
wherein the second end of the elongated member is attached to said food article.

12. The decorative toothpick device of claim 11, wherein the chocolate molded topper comprises an edible additive.

13. The decorative toothpick device of claim 12, wherein the edible additive comprises at least one of luster dust, edible glitter, edible decorations, sprinkles, edible paint, frosting, edible picture image, or fondant.

14. The decorative toothpick device of claim 11, wherein the food article comprises at least one of a chocolate-covered strawberry, a caramel apple, a cupcake, a cookie, a cake pop, or a pastry.

15. The decorative toothpick device of claim 11, wherein the chocolate molded topper is shaped as an eyelash.

16. The decorative toothpick device of claim 11, wherein the chocolate molded topper is shaped as a bridal tiara and veil.

17. The decorative toothpick device of claim 11, wherein the chocolate molded topper is shaped as a groom's hat.

18. A decorative toothpick device, comprising:
a toothpick comprising a first end and a second end; and
a candy molded topper secured to the first end of the toothpick; and
wherein the second end of the toothpick is then inserted into a cupcake.

19. The decorative toothpick device of claim 18, wherein the candy molded topper comprises an edible additive.

20. The decorative toothpick device of claim 19, wherein the edible additive comprises at least one of luster dust, edible glitter, edible decorations, sprinkles, edible paint, frosting, edible picture image, or fondant.
